(19) United States
(12) Patent Application Publication
(10) Pub. No.: US 2003/0221448 A1
(43) Pub. Date: Dec. 4, 2003

(54) Method of producing high-purity helium

(76) Inventors: Kazuo Shoji, Narashino-shi (JP); Atsushi Moriya, Narashino-shi (JP)

Correspondence Address: FLYNN THIEL BOUTELL & TANIS, P.C., 2026 RAMBLING ROAD, KALAMAZOO, MI, 49008-1699, US

(21) Appl. No.: 10/444,052

(22) Filed: May 22, 2003

(30) Foreign Application Priority Data
May 28, 2002 (JP) 2002-154452

(51) Int. Cl. B01D 53/22; B01D 59/12; C01B 3/00; B01J 8/00; B01D 47/00; F25J 3/00

(52) U.S. Cl. 62/639; 423/210; 95/53; 96/10

(57) ABSTRACT

A method of producing high-purity helium, which contains the step of: producing high-purity helium of 99.99 mol % or higher, by a process in which crude helium having a helium concentration of 40 to 90 mol % is, at least, permeated through a separation membrane module composed of a plurality of glass hollow fiber membrane.

### FIELD OF THE INVENTION

The present invention relates to a method of separation/purification of helium. More specifically, the present invention relates to a method of producing high-purity helium, in which the system structure is simpler than the conventional system, and energy consumption is lower.

### BACKGROUND OF THE INVENTION

Helium gas has many uses, such as in optical fiber production, welding, analysis, and the like. In addition, the boiling point of liquid helium is approximately −270° C., and thus its importance as a cooling medium, for the extremely low temperatures of superconductivity and the like, is increasing. Helium with purity of 99.995 mol % (CGA (Compressed Gas Association) G-9.1 Grade A), or with purity of 99.997 mol % (CGA G-9.1 Grade B), is being distributed in the market as high-purity helium.

Helium is industrially produced by being separated from natural gas, which contains a relatively high concentration of helium. In other words, hydrocarbons such as methane are separated from natural gas, from which acidic gases and moisture content have been removed, to thereby produce crude helium gas that is mainly composed of helium and nitrogen. The nitrogen gas is then separated, thereby producing high-purity helium.

Methods well known in the field of high-purity helium gas production include a cryogenic (low-temperature) separation process, a combination of the cryogenic separation process and a PSA (pressure swing adsorption); and a combination of the cryogenic separation process, a gas separation membrane process, and the PSA process.

The cryogenic separation process is a method that gives an extremely low temperature by utilizing the physical phenomena by which temperature is lowered by expanding a high-pressure gas, and then the gas is liquefied to separate. The greater the difference in pressure due to expansion, the lower the obtained temperature will be. Cryogenic separation is suitable for purification to obtain high purity, and for mass processing. However, a gas compression and expansion cycle to generate extremely low temperatures is necessary, and thus a feature of this process is high-energy consumption.

In the PSA process, a gaseous mixture is fed in vessels that have been filled with adsorption materials, such as zeolite which has a selective adsorption effect, and by changing pressure through the steps of: compression, adsorption, pressure reduction, and desorption, a desired component is selectively obtained from the gaseous mixture, and the desired component can be obtained with high purity. The system requires pipings to connect pressure vessels filled with adsorption agents, and switching valves to switch the flow passes, and thus the structure is complex.

The gas separation membrane process is a method in which a separation membrane, which allows molecules or compounds having a specific size or characteristic to selectively pass through, is used to selectively concentrate a desired component from a gaseous mixture. The gas separation membrane method is not suitable for high purification, but it is well known that the process has such features that, in the system, the energy consumption required for separation is low, and that the system structure is simple. The gas separation membrane to be used is often formed by a thin layer of a polymeric substance, such as polyolefin-based, cellulose-based or silicon-based.

In the helium production that is based on the features of separation and purification technologies, the cryogenic separation process is often used in the stage in which helium in natural gas is enriched, to obtain crude helium gas. In addition, the cryogenic separation process is also often used in the stage in which the crude helium gas is further purified, and high-purity helium gas is produced. The PSA process is used as a means to obtain high-purity helium gas from the crude helium gas. The gas separation membrane process is used as a means for producing crude helium gas from natural gas. The gas separation membrane process is also used as a means for enriching helium gas from crude helium, but because it is not suitable for high-level purification, it is not used as a means for producing helium of CGA G-9.1 Grade A (simply referred to as “Grade A” hereinafter), or helium of high level of purity according to the Grade A.

A method of producing helium using a combination of the cryogenic separation process and the gas separation membrane process, in which a gaseous mixture of helium and air is used as the feed, is disclosed in JP-A-8-261645 (“JP-A” means an unexamined and published Japanese patent application). In this method, first, most of nitrogen and oxygen is removed from the gaseous mixture of helium and air by a cryogenic separation process, and crude helium of about 95% purity is obtained, and then the purity is increased to 99% by a gas separation membrane process. To obtain the higher purity of helium by the gas separation membrane process used in this method, it is necessary to increase the concentration of helium to the higher level at the cryogenic separation process stage, but, to liquefy and separate constituents other than helium, a very large compression power is required in the cryogenic separation unit. In addition, in this method, because production of high-purity helium is difficult with just the combination of the cryogenic separation process and the membrane separation process, an adsorption unit is additionally provided at the next stage of the gas separation membrane unit, to obtain high-purity helium.

In this manner, to produce high-purity helium of purity 99.99 mol % or higher by this method, it is necessary to utilize an adsorption unit, such as a PSA. Accordingly, there has been a problem that a complex purification process in which many purification systems are combined, is necessary.

Also, the method of carrying out separation of helium from natural gas in which a combination of the cryogenic separation process and the gas separation membrane process is used, is disclosed, for example, in JP-A-54-110193. In this example, helium with high purity of 99.95% is obtained, by using a gas separation membrane having cellulose acetate as a base, from crude helium that contains about 70% helium and about 30% nitrogen and that is obtained from a cryogenic separation unit.

In this method, despite that a complicated system structure is adapted, in which five stages of the gas separation membrane unit are connected in series, only helium with purity of 99.95 mol % or 99.97 mol % level is obtained. This shows that it is difficult for higher-purity helium with purity of 99.99 mol % or higher, or Grade A level purity, to be produced from a combination of the cryogenic separation process and the gas separation membrane process. To further improve the purity of the helium obtained in this method, a PSA unit must be used in combination, or even more stages of gas separation membrane units must be used, and so the technology in which the cryogenic separation process and the gas separation membrane process are combined, is not used as a practical method to produce high-purity helium.

A method using a PSA process is disclosed, for example, in JP-B-5-77604 (“JP-B” means an examined Japanese patent publication), in which high-purity helium is produced from natural gas as the feed. By this method, high-purity helium is obtained from a relatively low-purity gaseous mixture that contains about 10% by volume of helium, and the PSA has two stages; and, in the first stage, crude helium, with purity of 95% by volume is obtained, and then in the second stage, high purity helium, with purity of 99.9% by volume or higher is obtained.

As described in JP-B-5-77604, basically, the PSA unit uses a plurality of adsorption columns, and a cycle of compression, adsorption, pressure reduction, and desorption are accomplished by switching valves. For this reason, there is a problem that there are a large number of pipings to connect the adsorption columns, as well as valves to switch the connection pipings, and thus the system structure is complex, and accordingly, operation is also complex.

In addition, due to the nature of PSA process, reducing the pressure of the filling vessels is necessary to regenerate the adsorbent. Thus a vacuum pump is necessary in many cases, resulting that the overall configuration of the PSA unit becomes even more complex, and the required power for the unit increases.

Further, to process the larger amount of gaseous mixture, a plurality of trains of the processing units are often used, causing another problem that the total system structure becomes more and more complex.

As described above, all of the conventional methods for producing helium with high purity of 99.99 mol % or higher from crude helium, have one or both of the following problems: the energy consumption is high, and/or the system structure is complex.

### SUMMARY OF THE INVENTION

The present invention is a method of producing high-purity helium, which comprises the step of: producing high-purity helium of 99.99 mol % or higher, by a process in which crude helium having a helium concentration of 40 to 90 mol % is, at least, permeated through a separation membrane module composed of a plurality of glass hollow fiber membrane.

Other and further features and advantages of the invention will appear more fully from the following description, taken in connection with the accompanying drawings.

### BRIEF DESCRIPTION OF THE DRAWINGS

FIG. 1 is a process chart showing an embodiment of the present invention.

FIG. 2(A) is a structural view showing an example of a glass hollow fiber membrane module. FIG. 2(B) is an enlarged view of the glass hollow fiber membrane (25).

FIG. 3 is a process chart illustrating production of high-purity helium using a cryogenic separating unit.

FIG. 4 is a process chart showing another embodiment of the present invention.

### DETAILED DESCRIPTION OF THE INVENTION

According to the present invention, there is provided the following means:

(1) A method of producing high-purity helium, comprising the step of:

producing high-purity helium of 99.99 mol % or higher, by a process in which crude helium having a helium concentration of 40 to 90 mol % is, at least, permeated through a separation membrane module composed of a plurality of glass hollow fiber membrane.

(2) The method according to item (1) above, wherein an outer diameter of the glass hollow fiber membrane is 40 to 150 μm.

(3) The method according to item (1) above, wherein the crude helium contains nitrogen or air at a concentration of 10 to 60 mol % as an impurity in the crude helium.

(4) The method according to item (1) above, wherein the separation membrane module is composed of at least one bundle of a plurality of the glass hollow fiber membrane.

Hereinafter, the present invention will be described in detail.

As a result of intensive studies, the inventors of the present invention have found that, to obtain high-purity helium from crude helium having a helium purity of about 40 to about 90 mol %, which is obtained by an arbitrary process with a cryogenic separation unit and the like, with natural gas as the feed, helium with high purity of 99.99 mol % or higher can be obtained, by using a glass hollow fiber membrane module, without using a PSA unit, with a simple apparatus structure and with fewer processing steps. The present invention has been completed based on this finding.

According to the present invention, because helium and nitrogen can be separated from each other with high selectivity, a refrigerating power (refrigeration cycle compression power) necessary to cool to −200° C., which is needed to liquefy and separate the nitrogen with a conventional cryogenic separation unit for producing high-purity helium gas, becomes unnecessary.

In the present invention, use is made of a gas separation membrane module that uses a glass hollow fiber membrane, as the gas separation membrane. The glass hollow fiber membrane that can be used in the present invention is produced by, for example, making a glass containing alkali metal ions into a hollow fiber in a usual manner, leaching the alkali metal ions from the hollow fiber with an acid, and forming micropores with a maximum diameter of 1.5 nm at the positions of the alkali metal ions which have been leached from the wall surface of the hollow fibers. In the present invention, use can be made of the glass hollow fiber membrane, as described, for example, in European Patent No. EP 0708061-B1 and Chemistry Communication (Chem. Commun.) 2002, 664.

The performance of a glass hollow fiber membrane in selectively separating helium/nitrogen is extremely high, and the glass hollow fiber membrane is thus preferable for purification/separation of a crude helium gas obtained from the fed natural gas, which is a gaseous mixture containing nitrogen and helium. Further, the performance in selectively separating helium/oxygen is also high, and the glass hollow fiber membrane is preferable for regeneration of a high-purity helium, which has been used and is contaminated with air.

For example, in a conventional polymer-based separation membrane, a selective permeation rate of helium and nitrogen is at most about 100. On the contrary, the glass membrane has a selective permeation rate of helium in the extremely high range of about 1800 to about 2000. In addition, the helium/oxygen selective permeation rate is excellently high in the range of 150 to 200, compared to the rate of 30 in a conventional technique.

Also, by making the gas separation membrane from a glass hollow fiber membrane, the surface area per unit volume for the membrane module can be made greatly larger, and the processing capacity for each unit volume of the membrane module can be increased. As a result, according to the present invention, an apparatus using the glass hollow fiber separation membrane, which has quite high separation performance, and which is a compact separation apparatus, can be completed, which could not be realized with the conventional polymer-based separation membrane.

In the present invention, the unit for the process of permeating through the separation membrane module, which is composed of a plurality of the glass hollow fiber membrane, is not limited to those having one stage, but may have 2 or more stages. In this case, it is preferable that a compressor(s) is provided between each of the two stages, to compress the gas, which has permeated through the separation membrane module of the preceding stage.

Hereinbelow, the method of the present invention will be described in detail based on the drawings.

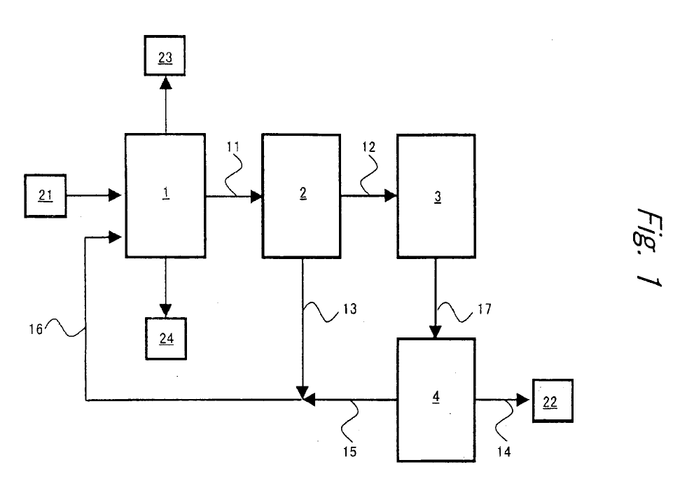

FIG. 1 is a process chart illustrating a preferable example of the process for producing helium from natural gas as a raw material. Natural gas contains methane as its main component, and it also contains nitrogen, carbon dioxide, hydrocarbons having a molecular weight higher than methane, sulfur compounds such as hydrogen sulfide, moisture, and helium. In the case of natural gas that contains a large amount of nitrogen, for the purpose of selling such a natural gas as a pipeline gas, it is necessary to remove the nitrogen and increase a heating valve of the natural gas. Generally, nitrogen removal is carried out by cryogenic separation. In the case of natural gas that contains both nitrogen and helium at high concentrations, by removing the nitrogen, the helium is also concentrated, thereby crude helium gas can be obtained.

First, acidic gases such as carbon dioxide and sulfur compounds, and moisture are removed from the natural gas in a pretreatment facility (not shown), to give a gaseous mixture of hydrocarbons, nitrogen and helium. The resultant pretreated natural gas (natural gas feed) 21 is introduced into a cryogenic separation unit 1, to separate into a natural gas product 24, nitrogen 23, and crude helium. The crude helium is taken out from the cryogenic separation unit 1 through a line 11. The purity of helium in the crude helium at the line 11 depends on the concentration of the helium originally contained in the natural gas, but it is preferably 40 to 90 mol %, and more preferably 60 to 80 mol %. This purity is determined based on the balance of the power for refrigeration necessary at the cryogenic separation unit to give crude helium, the processing capacity of the glass hollow fiber membrane unit to give high-purity helium, i.e. the number of membrane modules, and the targeted purity of the product helium. As a system configuration, an operation method, and the like of the cryogenic separation unit to produce crude helium, those in the conventional methods can be applied.

The thus-obtained crude helium in the line 11, after being compressed if necessary, is introduced into a first glass hollow fiber membrane unit (hereinafter, referred to as a first glass membrane unit) 2 equipped with at least one separation membrane module. In the unit, helium is selectively permeated through, and helium concentration in the permeated gas (in a line 12) becomes higher than that in feed gas.

The helium in the line 12 is introduced into a compressor 3 and compressed, and the resultant compressed helium is then introduced, through a line 17, into a second glass hollow fiber membrane unit (hereinafter, referred to as a second glass membrane unit) 4 that is equipped with at least one separation membrane module, to further remove impurities, thereby obtaining a helium product. The helium product 22 that is a high-purity helium with purity of 99.99 mol % or higher, is obtained from a discharge port via a line 14. Gases with a high concentration of impurities, which are discharged from the first glass membrane unit 2 and the second glass membrane unit 4 respectively at a line 13 and a line 15, still contain a considerable amount of helium. Thus, these gases are returned to the cryogenic separation unit 1, through a line 16, which merges the line 13 and the line 15, to carry out reprocessing to improve the helium recovery rate. FIG. 1 shows a method in which two units of the first glass membrane unit and the second glass membrane unit are connected in series, but depending on the pressure and the purity of the crude helium to be supplied to the glass membrane unit, there may be a case having only one unit. Also, the first glass membrane unit may be replaced with a conventional gas separation membrane, and only the second glass membrane unit is a glass membrane unit. Alternatively, the configuration may be such that crude helium is made to permeate through three or more glass membrane units, which are preferably connected each other in series. When the glass membrane unit is composed of two or more separation membrane modules, the plural separation membrane modules are preferably connected in parallel in the unit.

In the present invention, the hollow glass membrane unit can be provided downstream from the cryogenic separation unit 1, as shown in FIG. 1. In addition to the above, the hollow glass membrane unit may be provided as a means to intermediate enrich or final enrich of helium, in a helium production process having the cryogenic separation process and the PSA process combined or in a helium production process constituted only with the cryogenic separation, each of which processes have been already provided. In this case, the load on the cryogenic separation unit or the PSA unit is reduced, and this contributes greatly to the enhancement of the performance of the existing facility.

Aside from use in the process for producing high-purity helium from natural gas, this system may also be used for purification of high-purity helium gas which has been used and contaminated with air. That is, because helium gas is expensive, in laboratories and the like, helium gas which has been used is collected, and the air which has been mixed in during use or collection is removed, thereby the resultant helium with improved purity is reused. Conventionally, for the purpose to achieve this, the cryogenic separation process, the gas separation membrane process, the PSA process and the like are used in the same manner as the method of producing high-purity helium from natural gas. By adopting the glass hollow fiber membrane, similarly in the method of producing high-purity helium from natural gas, the following effects can be expected: a facility with a simple structure of system can be adopted; the process can be made shorter or in the fewer number of steps; and the necessary power can be reduced.

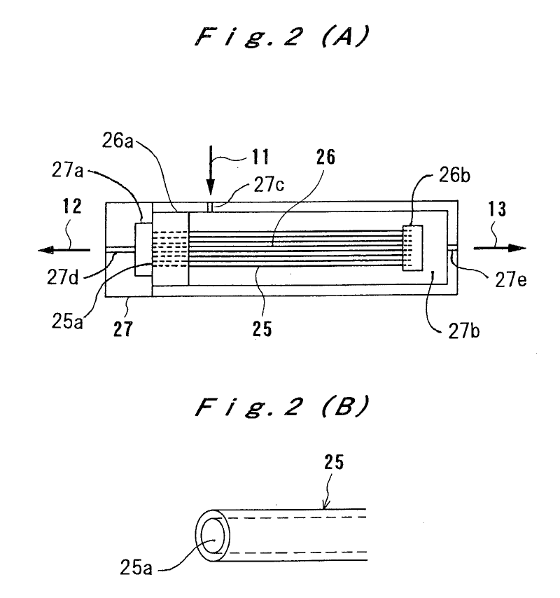

FIG. 2(A) shows a structural example of a typical separation membrane module composed of a plurality of glass hollow fiber membrane. The structure may be the same as that of the conventional hollow fiber-type module to be used in dialysis or ultra-filtration. In this case, the separation membrane module is composed of a shell 27 that is a pressure vessel for the module, and a hollow fiber membrane bundle 26 in which a plurality of glass hollow fiber membranes 25 are bundled together. The hollow fiber membranes 25 are bundled together at the both end portions thereof in the longitudinal direction, at a first fixing part 26a and a second fixing part 26b, to give the hollow fiber membrane bundle 26. The parts 26a and 26b may be formed by using a bonding agent and/or a filler. One end of the glass hollow fiber membrane 25 penetrates through the first fixing part 26a, connecting a space 27a outside of the part 26a with an opening 25a. The other end of the glass hollow fiber membrane 25 is embedded and sealed with the second fixing part 26b. In this example, 100° C. is the working temperature, and various polymers that can be handled relatively easily can be used as the bonding agent and the filler. A supply gas (the line 11) is supplied to the shell side through a passage 27c, and mainly helium permeates through the micropores (not shown) in the wall of the glass hollow fiber membrane 25, to be enriched in the hollow fibers. Thus, the resultant permeated helium gas is shown by the line 12. In the figure, 27d is a passage to connect the space 27a with the line 12. On the other hand, a non-permeated gas (the line 13), whose helium concentration has been reduced, is discharged from the second space 27b in the shell, through a passage 27e and an exit nozzle (not shown) of the shell. FIG. 2(B) is an enlarged view of the glass hollow fiber membrane 25.

In the present invention, the outer diameter of the glass hollow fiber membrane is preferably 40 to 150 μm, and more preferably 60 to 110 μm.

The thickness of the hollow fiber membrane (the thickness of the wall of the hollow fiber) is preferably 4 to 20 μm, and the diameter of the micropores that penetrate through the hollow fiber wall is preferably 1 nm or less.

The glass of the hollow fiber is preferably any kind of silicate glass that has been subjected to acid process to make it porous. Examples of the glass that is subjected to acid process to make it porous include, but are not limited to, soda borosilicate glass (borosilicate soda glass), and zirconium borosilicate glass (zirconium borosilicate soda glass).

The present invention can solve the problems of large amount of energy consumption and/or complex system structure, in the conventional methods for producing helium with high purity of 99.99 mol % or higher, from crude helium. In other words, the present invention can provide a method of producing helium with high purity of 99.99 mol % or higher, from a crude helium gas feed having helium purity of about 40 to about 90 mol %, in which method the energy consumption is small, and the system structure is simple, and the method is excellent in economic efficiency.

According to the present invention, the power necessary for high-degree purification of helium can be greatly reduced, as compared to that necessary in the conventional production method. Further, there is no need to additionally provide a PSA unit, which necessitates a complex system structure, and helium with extremely high-purity can be produced in a short process, i.e. in fewer processing steps or shorter processing time.

The present invention will be described in more detail based on examples given below, but the invention is not meant to be limited by these examples. The pressure values shown in the examples and comparative example below represent absolute pressure, unless otherwise specified.

### EXAMPLES

### Example 1

High-purity helium was produced from natural gas according to the process, as shown in FIG. 1.

Natural gas obtained from well heads was subjected to removal of acidic gases such as carbon dioxide and hydrogen sulfide, and moisture, in a pretreatment facility (not shown), and the resultant natural gas was supplied to the cryogenic separation unit 1 as the natural gas feed 21. This natural gas feed contained 60.0 mol % of methane, 1.5 mol % of helium, and the balance was mainly nitrogen. The processing amount of the natural gas feed was 120,000 Nm³/hour. Herein, the processing amount (Nm³/hour) is shown in terms of a flow rate per hour at 0° C., 1 atm (101325 Pa).

In this example, a membrane module of diameter 20 cm and length 3.5 m having a bundle of a plurality of glass hollow fiber membrane of diameter 70 μm, was prepared, according to the descriptions in the above European Patent No. EP 0 708 061-B1 and Chemistry Communication (Chem. Commun.), 2002, 664. The membrane module, as a basic unit, was provided such that 16 of the units were aligned in parallel in the first glass membrane unit 2, and 4 of the units were aligned in parallel in the second glass membrane unit 4. The glass hollow fiber membrane which was used as a gas separation membrane, had a helium and nitrogen separation/selection ratio of 1,900 at 100° C.

Firstly, the natural gas feed 21 was introduced into the cryogenic separation unit 1, and crude helium with a purity of 70 mol % was obtained from the line 11 at 2,300 Nm³/hour. The pressure of the line 11 was 1.27 MPa. At the same time, from the cryogenic separation unit 1, the methane product 24 of a nitrogen content of 3.0 mol % was obtained at 74,000 Nm³/hour, and the nitrogen 23 with a concentration of 98 mol % or higher was obtained at 44,000 Nm³/hour, respectively.

The crude helium sent through the line 11, was introduced into the first glass membrane unit 2 at a pressure of 1.27 MPa, and by making the helium permeate through the hollow glass fiber, nitrogen which accounted for most of the impurity was removed. The pressure at the permeation side was 120 kPa (the line 12). The non-permeated gas containing a high concentration of nitrogen sent via the line 13, was mixed with another non-permeated gas via the line 15 of the subsequent stage, and the resulting gaseous mixture was sent through the line 16 into the cryogenic separation unit 1 to recycle. The permeated helium was sent through the line 12 and was introduced into the compressor 3, in which the pressure was increased to 1.27 MPa. Then, the compressed helium was sent through line 17 to the second glass membrane unit 4 in which the purity was further increased. In this case, the pressure at the side of the permeated gas was 120 kPa (the line 14).

The power necessary for this system was that of the compressor at the entrance of the second glass membrane unit, and this compression power was 203 kW.

The helium that had permeated through the second glass membrane unit 4 was high-purity helium of purity 99.9995 mol %, which is higher than that of Grade A helium (99.995 mol % purity). The thus-obtained high-purity helium gas was taken from the line 14 as the helium product 22. Subsequently, the helium product can be adjusted to a desired pressure, filled in a cylinder or the like, to sell in the market.

On the other hand, the component remained after the separation at the second glass membrane unit 4 was composed of nitrogen and helium as its main components, and these components were recycled into the cryogenic separation unit 1 via the line 15, to improve the recovery rate of helium.

In this example, the helium recovery rate in the two-stage glass membrane units was 95%. In this connection, the gas that has not been recovered can also be recycled by being sent to the glass membrane units via the cryogenic separation unit, and thus substantially almost 100% of the helium recovery rate will be achieved.

The flow rate, composition, pressure and temperature in the lines 11, 12, 14 and 17 in this example are shown in Table 1.

Table 1

TABLE 1

| Line No. | | | 11 | 12 | 17 | 14 |
|---|---|---|---|---|---|---|
| Flow rate | Nm³/hr | He | 1610.0 | 1536.5 | 1536.5 | 1533.7 |
| | Nm³/hr | N₂ | 690.0 | 2.2 | 2.2 | 0.0 |
| | Nm³/hr | Total | 2300.0 | 1538.7 | 1538.7 | 1533.7 |
| Composition | mol % | He | 70.00 | 99.86 | 99.86 | 99.9995 |
| | mol % | N₂ | 30.00 | 0.14 | 0.14 | 0.0005 |
| Pressure | MPa | | 1.27 | 0.12 | 1.27 | 0.12 |
| Temperature | ° C. | | 100 | 100 | 100 | 100 |

### Comparative Example 1

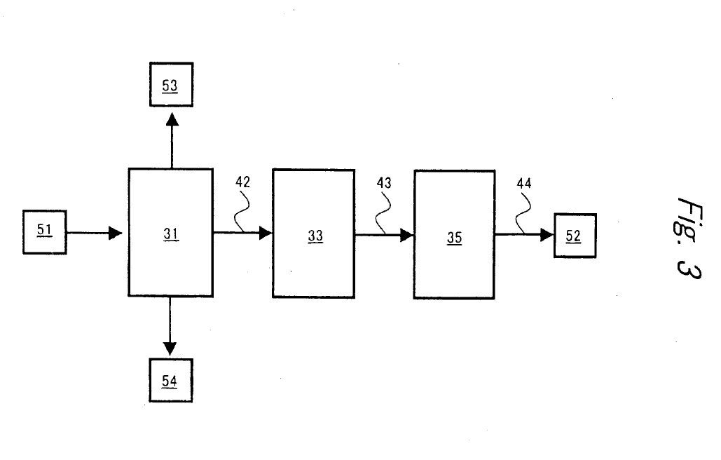

Purification of crude helium was carried out, according to a conventional cryogenic separation process, as shown in FIG. 3.

Natural gas obtained from well heads was subjected to removal of acidic gases such as carbon dioxide and hydrogen sulfide, and moisture, in a pretreatment apparatus (not shown), and the resultant natural gas was supplied to a cryogenic separation unit 31 as a natural gas feed 51. This natural gas feed 51 was separated into a natural gas product 54, nitrogen 53, and a crude helium. When supplied to a helium purification cryogenic separation unit 35, the pressure of the crude helium gas (in a line 42) obtained above at 2,300 Nm³/hour, must be sufficiently high, taking the liquefying temperature of nitrogen into consideration. For example, a pressure of 18.7 MPa may be adopted. The power necessary for this system was the total of the power at a compressor 33 necessary for increasing the pressure of the crude helium gas (the line 42) from 1.27 MPa to the prescribed pressure of 18.7 MPa which was necessary for cryogenic separation, and the power for the nitrogen refrigeration cycle necessary at the helium purification cryogenic separation unit 35. In the nitrogen refrigeration cycle, in order to cool down the pressurized crude helium gas (in a line 43) to a level of −196 to −206° C. which was the temperature level necessary for purifying, the cooling medium was obtained by, for example, compressing nitrogen from 0.12 MPa to 4.24 MPa, and then expanding it by adiabatic expansion or in an expander.

The helium purified in the helium purification cryogenic separation unit 35 was sent through a line 44, to give a helium product 52.

In the comparative example, the compression power for the compressor 33, which was necessary for increasing the pressure of the crude helium gas (line 42), was 342 kW. This figure is largely higher than the compression power necessary in Example 1. Since a compression power for the refrigeration cycle is further necessary, it is apparent that the comparative example needs a conspicuously larger compression power, as compared to Example 1. In addition, the system for the comparative example needs a large number of flash drums and distillation columns of extremely low temperature services, which are stored in a cryogenic box, and thus the system for the comparative example is disadvantageous in view of complexity and operativity.

### Example 2

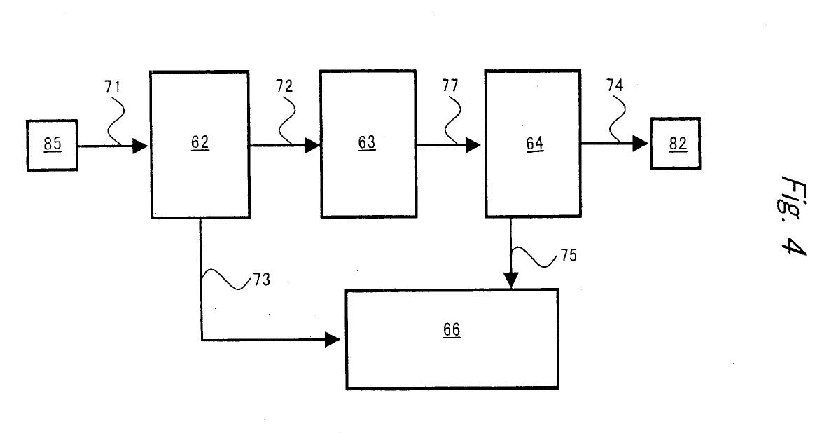

Helium gas which had been mixed with air in an amount of 30 mol % was purified in a two-stage glass membrane system similar in Example 1. FIG. 4 shows the flow chart for this process.

Crude helium 85 contaminated with 30 mol % of air had a composition of 70 mol % of helium, 6.3 mol % of oxygen, and 23.7 mol % of nitrogen. This crude helium was introduced, through a line 71, to a first glass membrane unit 62 at a pressure of 1.27 MPa. By making the helium permeate through glass hollow fibers in the unit, nitrogen which accounted for most of the impurities was removed. The pressure at the permeated gas side was 120 kPa. The non-permeated gas containing a high concentration of nitrogen may be discharged into the atmosphere from a line 73 together with a gas from a line 75, which is from the subsequent stage. Alternatively, when there is provided another unit for concentration, the above gases from the lines 73 and 75 may be stored in a low-concentration helium holder 66 as a feed for the another concentration unit. The helium which permeated through the unit 62 (helium 99.6 mol %, oxygen 0.3 mol %, nitrogen 0.1 mol %) was sent through a line 72 and was introduced into a compressor 63, to increase the pressure to 1.27 MPa. Then, the pressurized helium was sent through a line 77, and it was introduced in a second glass membrane unit 64, to further increase the purify. The pressure of the gas that permeated through the unit 64 was 120 kPa (a line 74).

When crude helium gas was processed at 2,300 Nm³/hour in this system, the amount of gas that permeated through the first glass membrane unit was 1,536 Nm³/hour. The power required by this system was that at the compressor 63 at the entrance of the second glass membrane unit 64, and the compression power was 301 kW.

The flow rate, composition, pressure and temperature in lines 71, 72, 74 and 77 in this example are shown in Table 2.

TABLE 2

| | | | Line No. | | | |
|---|---|---|---|---|---|---|
| | | | 71 | 72 | 77 | 74 |
| Flow rate | Nm³hr | He | 1610.0 | 1529.65 | 1529.65 | 1439.04 |
| | Nm³hr | O₂ | 144.9 | 4.15 | 4.15 | 0.07 |
| | Nm³hr | N₂ | 545.1 | 1.69 | 1.69 | 0.00 |
| | Nm³hr | Total | 2300.0 | 1535.48 | 1535.48 | 1439.11 |
| Composition | mol % | He | 70.00 | 99.6 | 99.6 | 99.995 |
| | mol % | O₂ | 6.3 | 0.3 | 0.3 | 0.005 |
| | mol % | N₂ | 23.7 | 0.1 | 0.1 | 0.000 |
| Pressure | MPa | | 1.27 | 0.12 | 1.27 | 0.12 |
| Temperature | ° C. | | 100 | 100 | 100 | 100 |

The helium which permeated through the second glass membrane unit 64 was a high-purity helium with purity that reaches the Grade A level of 99.995 mol % purity. The thus-obtained high-purity helium gas is taken from the line 74 as a helium product 82. Subsequently, the helium product can be adjusted to a predetermined pressure, and filled in a cylinder or the like, to thereby reuse.

The nitrogen-helium separation process, feed gas composition, concentration of the helium product, and power to be used, utilized in Examples 1 and 2, and Comparative example 1, are shown in Table 3.

TABLE 3

| | | Comparative | |
|---|---|---|---|
| | Example 1 | example 1 | Example 2 |
| N₂—He | Grass hollow | Cryogenic | Grass hollow |
| separation | fiber membrane | separation | fiber membrane |
| method | method | method | method |
| Feed gas | He:70 | He:70 | He:70 |
| composition | N₂:30 | N₂:30 | N₂:23.7 |
| (mol %) | | | O₂:6.3 |
| Purity of | 99.9995 | 99.997 | 99.995 |
| helium product | mol % | mol % | mol % |
| Comparison of | 203 kW | 342 kW* | 301 kW |
| compression | | | |
| power | | | |

(Note)
*In addition to this, compression power for refrigeration cycle in the helium purification cryogenic separation unit was necessary.

Having described our invention as related to the present embodiments, it is our intention that the invention not be limited by any of the details of the description, unless otherwise specified, but rather be construed broadly within its spirit and scope as set out in the accompanying claims.

What we claim is:

1. A method of producing high-purity helium, comprising the step of:
producing high-purity helium of 99.99 mol % or higher, by a process in which crude helium having a helium concentration of 40 to 90 mol % is, at least, permeated through a separation membrane module composed of a plurality of glass hollow fiber membrane.

2. The method according to claim 1, wherein an outer diameter of the glass hollow fiber membrane is 40 to 150 μm.

3. The method according to claim 1, wherein the crude helium contains nitrogen or air at a concentration of 10 to 60 mol % as an impurity in the crude helium.

4. The method according to claim 1, wherein the crude helium is permeated through at least two units connected in series, each of the units being provided with at least one separation membrane module.

5. The method according to claim 1, wherein a thickness of the glass hollow fiber membrane is 4 to 20 μm.

6. The method according to claim 1, wherein a diameter of micropores that penetrate through a fiber wall of the glass hollow fiber membrane is 1 nm or less.

7. The method according to claim 1, wherein the separation membrane module is composed of at least one bundle of a plurality of the glass hollow fiber membrane.
